(19) United States
(12) Patent Application Publication
(10) Pub. No.: US 2026/0270098 A1
(43) Pub. Date: Sep. 10, 2026

(54) CONFIGURING OF CHARGING TRIGGERS USING CHARGING TRIGGER PROFILES

(71) Applicant: Telefonaktiebolaget LM Ericsson (publ), Stockholm (SE)

(72) Inventors: Ramanathan OPPILAMANI, Chennai (IN); Rameshwaran THULASIDOSS, Chennai (IN); A. K. DIWAHAR, Chennai (IN); Robert TÖRNKVIST, Karlskrona (SE)

(73) Assignee: Telefonaktiebolaget LM Ericsson (publ), Stockholm (SE)

(21) Appl. No.: 19/167,465

(22) PCT Filed: Apr. 4, 2023
(86) PCT No.: PCT/EP2023/058809

§ 371 Date: Sep. 24, 2025

(51) Int. Cl. H04L 12/14; H04M 15/00

(52) U.S. Cl. CPC H04L 12/1403; H04M 15/62

(57) ABSTRACT

A method for configuring charging triggers in an NF is provided. The method includes the NF obtaining a set of charging trigger profiles, wherein each charging trigger profile defines one or more configurations of charging triggers. The method includes the NF receiving, as part of a charging data response from a CHF, an indication of a particular charging trigger profile. The method includes configuring the NF to report charging events to the CHF in accordance with at least one configuration of charging triggers defined by the particular charging trigger profile. A corresponding method performed in the CHF, an NF entity, a CHF entity, and computer programs and computer program products are also provided.

### TECHNICAL FIELD

The present disclosure relates to the field of cellular networks. In particular, the present disclosure relates to the configuring of charging triggers in such networks.

### BACKGROUND

In fifth generation (5G) telecommunication architectures, charging triggers (as described in e.g. 3GPP TS 32.290/291) are reported in and configured using charging control application responses. For example, a Network Function (NF) may send a charging data request [initial, update or terminate] to a Converged Charging Function (CHF). The CHF then sends back to the NF a corresponding charging data response, which may include information regarding how the charging triggers of the NF and its corresponding Charging Trigger Function (CTF) are to be configured.

The charging trigger conditions in the NF (CTF), such as e.g. a Session Management Function (SMF), may thus be set from the CHF on a per-charging session basis. The charging trigger conditions can e.g. be set to be immediate or deferred, enabled or disabled, and some may have e.g. one or more values associated therewith in form of e.g. limits and/or thresholds. In current architectures, when updating for example one particular charging trigger, the CHF is also required to include all other charging triggers which are to remain enabled as part of the charging data response sent to the NF (CTF). If a particular charging trigger is not included as part of such a charging data response, the receiving NF (CTF) is to interpret this as an instruction to disable that particular charging trigger (if currently enabled).

### SUMMARY

As the trigger condition details are only sent to from the CHF to the NF (CTF) in response to an incoming charging data request, immediate updating of a charging trigger condition in the NF (CTF) is often not possible. Instead, before any update of a charging trigger for a current charging session can be made, the CHF would first have to wait for a next charging data request to arrive from the NF (CTF). In addition to such delay, as each update of a particular charging trigger necessitates also the (re-)sending of information pertaining to all other charging triggers, at least some part of the information sent between the NF (CTF) and the CHF may be considered as being redundant and increasing the amount of data-transferring required for the configuring of the charging triggers.

In light of at least these disadvantages of currently available technology, there is therefore a need for an improved way of configuring (and assisting in configuring) charging triggers in e.g. a Network Function (NF). For this purpose, to at least partially satisfy such a need, the present disclosure provides a method, computer program and computer program product for configuring charging triggers in an NF, an NF entity, as well as a method, computer program and computer program product for assisting in configuring charging triggers in an NF, and a Charging Function (CHF) entity, as defined in and by the accompanying independent claims. Various embodiments of the methods, NF and CHF entities, computer programs and computer program products are defined in and by the accompanying dependent claims.

According to a first aspect, there is provided a method for configuring charging triggers in a Network Function (NF). The method is performed by/in the NF itself, and includes obtaining a set of one or more charging trigger profiles, wherein each charging trigger profile defines one or more configurations of charging triggers. The method includes receiving, as part of a charging data response from a Charging Function (CHF), an indication of a particular charging trigger profile in the set of one or more charging trigger profiles. The method further includes configuring the NF to report charging events to the CHF in accordance with at least one of the one or more configurations of charging triggers defined by the particular charging trigger profile.

As used herein, a “charging trigger” has the same meaning as defined in e.g. 3GPP TS 32.290/291 and 32.255, i.e. an entity of data type “Trigger” which defines conditions for when a chargeable event is said to occur, and used for reporting of charging information for offline or online charging (deferred or immediate triggers). A “set of one or more charging trigger profiles” includes at least one charging trigger profile. A “configuration of charging triggers” is a set of one or more charging triggers that the NF should use to define which chargeable events that should be reported back to the CHF, and optionally includes also one or more definitions of thresholds and/or limits. As will be described in more detail later herein, a configuration of triggers may e.g. be defined in the charging trigger profile as a new data type “TriggerList”, including an array of one or more charging triggers (data type “Trigger”) as well as e.g. various limits and thresholds. That the method is performed by/in the NF may include e.g. that it is a Charging Trigger Function (CTF) of the NF which uses the charging triggers to report charging events to the CHF.

The envisaged method improves upon currently available technology and architectures in that by introducing charging trigger profiles, the signaling between the CHF and the NF (CTF) may be reduced as the exchanged information may be kept to a minimum and control of when/how to send charging data requests/responses may be controlled in more detail. In addition, as a same charging trigger profile may be used by the NF for different charging sessions, the envisaged method also allows to reduce the delay until the CHF gets the opportunity to update/configure the charging triggers that are to be used by the NF for a particular charging session. Instead of having to wait for a charging data request to arrive from the NF for the particular charging session, the CHF may communicate the updates to the charging trigger profile as soon as any charging data request is received from the NF for any charging session. The advantages of the envisaged method will be described in more detail later herein, in the section “Detailed description”.

In one or more embodiments of the method, at least the particular charging trigger profile may be obtained as part of the charging data response received from the CHF. This allows the CHF to distribute charging trigger profiles to NFs as part of a charging data response. This may be useful e.g. to communicate a charging trigger profile to the NF for the first time, and/or to e.g. communicate one or more changes to such a charging trigger profile (i.e. an update of the charging trigger profile) to the NF. In addition, the ability to distribute/communicate the charging trigger profile via the charging data response can be useful e.g. for event based charging, in which it may usually (with commonly available technology and architectures) be challenging or impossible to set any charging triggers from the CHF.

In one or more embodiments of the method, at least the particular charging trigger profile may have been configured in the NF before receiving the charging data response. The charging trigger profile may e.g. be configured and managed from e.g. an operation support system. For example, the NF may be configured/provided with a default charging trigger profile such that there is always at least one charging trigger profile available to the NF even before having received any charging data response from the CHF. For example, the NF may be so configured before the NF is commissioned.

In one or more embodiments of the method, the method may include obtaining the particular charging trigger profile as part of a first charging data response from the CHF. The method may further include receiving the indication of the particular charging trigger profile as part of a second charging data response from the CHF, wherein the second charging data response is received later from the CHF than the first charging data response, and wherein the second charging data response defines one or more updates of the one or more configurations of charging triggers defined by the particular charging trigger profile. The method may further include applying the one or more updates as part of the configuring of the NF. As envisaged herein, the CHF may provide only the information needed to perform updates of one or more charging triggers in the NF, without having to resend all information about all other charging triggers for each such update. This may help to reduce e.g. the amount of network data that is transferred in order to perform such updating of a charging trigger. This can be obtained by the CHF by referencing a charging trigger profile which the NF has already received, as part of an earlier charging data response sent from the CHF to the NF.

In one or more embodiments of the method, the method may include receiving the charging data response from the CHF as part of a first charging session. The method may further include configuring the NF for a second charging session which is different from the first charging session. For example, this may include configuring the NF in response for a next request of e.g. a user equipment (UE)/PDE service session/event (i.e., in response to/for a next request of a UE/PDE service session/event). As described earlier herein, this reduces the delay present in currently available architectures, as the CHF does not have to wait for an incoming charging data request associated with a same charging session before being able to tell the NF to update its charging trigger(s). Instead, the CHF may act as soon as a charging data request is received for any charging session, which reduces the delay. Likewise, as soon as the NF receives the updates of a particular charging trigger profile as part of a charging data response for a first charging session, the NF may proceed by implementing these changes for all charging sessions which are to use the particular charging trigger profile.

In one or more embodiments of the method, the one or more configurations of charging triggers for the particular charging trigger profile may include a configuration of charging triggers for each of a plurality of different rating groups. The method may include configuring the NF in accordance with the configuration of charging triggers for a particular one of the different rating groups. In one or more other embodiments of the method, the one or more configurations of charging triggers for the particular charging trigger profile may instead be applicable for a PDU session as a whole, and thus applicable to any rating group. Phrased differently, the envisaged charging trigger profiles and the charging triggers indicated may be used both on an overall PDU session-basis, or on a rating group-basis.

According to a second aspect, there is provided a method for assisting in configuring of charging triggers in a Network Function (NF). The method is performed in/by a Charging Function (CHF), and includes sending a charging data response to the NF, wherein the charging data response includes an indication of a charging trigger profile defining one or more configurations of charging triggers, in accordance with which the NF should be configured to report charging events to the CHF.

In one or more embodiments of the method, the method may include providing the particular charging trigger profile as part of the charging data response sent to the NF.

In one or more embodiments of the method, the particular charging trigger profile may be configured in the NF before sending the charging data response to the NF. As described earlier herein, the particular charging trigger profile (and others, if available) may e.g. be configured and managed from the operation support system.

In one or more embodiments of the method, the method may include providing the particular charging trigger profile as part of a first charging data response sent to the NF. The method may further include providing the indication of the particular charging trigger profile as part of a second charging data response sent to the NF, wherein the second charging data response is sent later to the NF than the first charging data response, and wherein the second charging data response defines one or more updates of the one or more configurations of charging triggers defined by the particular trigger profile.

According to a third aspect, there is provided a Network Function (NF) entity. The NF entity includes processing circuitry. To configure one or more charging triggers in the NF entity, the processing circuitry is configured to cause the NF entity to: i) obtain a set of one or more charging trigger profiles, wherein each charging trigger profile defines one or more configurations of charging triggers; ii) receive, as part of a charging data response from a Charging Function (CHF) entity, an indication of a particular charging trigger profile in the set of one or more charging trigger profiles; and iii) configure the NF entity to report charging events to the CHF entity in accordance with at least one of the one or more configurations of charging triggers defined by the particular charging trigger profile. Phrased differently, the processing circuitry of the NF entity is configured to cause the NF entity to perform the method of the first aspect.

In one or more embodiments of the NF entity, the processing circuitry may further be configured to cause the NF entity to perform any embodiment of the method of the first aspect as disclosed and discussed herein.

According to a fourth aspect, there is provided a Charging Function (CHF) entity. The CHF entity includes processing circuitry. For the CHF entity to assist in configuring of charging triggers in a Network Function (NF) entity, the processing circuitry is configured to cause the CHF entity to send a charging data response to the NF entity, wherein the charging data response includes an indication of a charging trigger profile defining one or more configurations of charging triggers, in accordance with which the NF entity should be configured to report charging events to the CHF entity. Phrased differently, the processing circuitry of the CHF entity is configured to cause the CHF entity to perform the method of the second aspect.

In one or more embodiments of the CHF entity, the processing circuitry may further be configured to cause the CHF entity to perform any embodiment of the method of the second aspect as disclosed and discussed herein.

According to a fifth aspect, there is provided a computer program for configuring charging triggers in a Network Function (NF) entity. The computer program includes computer code which, when run on processing circuitry of the NF entity, causes the NF entity to: i) obtain a set of one or more charging trigger profiles, wherein each charging trigger profile defines one or more configurations of charging triggers; ii) receive, as part of a charging data response from a Charging Function (CHF) entity, an indication of a particular charging trigger profile in the set of one or more charging trigger profiles; and iii) configure the NF entity to report charging events to the CHF entity in accordance with at least one of the one or more configurations of charging triggers defined by the particular charging trigger profile. Phrased differently, the computer code is such that it, when executed on the processing circuitry of the NF entity, causes the NF entity to perform the method of the first aspect.

In one or more embodiments of the computer program, the computer code may further be such that it, when executed on the processing circuitry of the NF entity, causes the NF entity to perform any embodiment of the method of the first aspect as disclosed and discussed herein.

According to a sixth aspect, there is provided a computer program product (for configuring of charging triggers in a Network Function (NF) entity). The computer program product includes a computer program according to the fifth aspect, and a computer-readable storage medium on which the computer program is stored. Phrased differently, the computer program product includes a computer-readable storage medium which stores the computer program of the fifth aspect.

According to a seventh aspect, there is provided a computer program for assisting in configuring of charging triggers in a Network Function (NF) entity. The computer program includes computer code which, when run on processing circuitry of a Charging Function (CHF) entity, causes the CHF entity to send a charging data response to the NF entity, wherein the charging data response includes an indication of a charging trigger profile defining one or more configurations of charging triggers, in accordance with which the NF entity should be configured to report charging events to the CHF entity. Phrased differently, the computer code is such that it, when executed on the processing circuitry of the CHF entity, causes the CHF entity to perform the method of the second aspect.

In one or more embodiments of the computer program, the computer code may further be such that it, when executed on the processing circuitry of the CHF entity, causes the CHF entity to perform any embodiment of the method of the second aspect as disclosed and discussed herein.

According to an eight aspect, there is provided a computer program product (for assisting in configuring of charging triggers in a Network Function (NF) entity). The computer program product includes a computer program according to the seventh aspect, and a computer-readable storage medium on which the computer program is stored. Phrased differently, the computer program product includes a computer-readable storage medium storing the computer program of the seventh aspect.

As used herein, a computer-readable storage medium (such as that of e.g. the sixth or eight aspect) may e.g. be non-transitory, and be provided as e.g. a hard disk drive (HDD), solid state drive (SDD), USB flash drive, SD card, CD/DVD, and/or as any other storage medium capable of non-transitory storage of data. In other embodiments, the computer-readable storage medium may be transitory and e.g. correspond to a signal (electrical, optical, mechanical, or similar) present on e.g. a communication link, wire, or similar means of signal transferring.

Other objects and advantages of the present disclosure will be apparent from the following detailed description, the drawings and the claims. Within the scope of the present disclosure, it is envisaged that all features and advantages described with reference to e.g. the method of the first aspect are relevant for, apply to, and may be used in combination with also the method of the second aspect, the entities of the third and fourth aspects, the computer programs of the fifth and seventh aspects, and the computer program products of the sixth and eight aspects, and vice versa.

### BRIEF DESCRIPTION OF THE DRAWINGS

Exemplifying embodiments will be described below with reference to the accompanying drawings, in which:

FIG. 1 schematically illustrates parts of a communication network relevant for the present disclosure;

FIG. 2A schematically illustrates the flow of interactions between an NF and CHF in various embodiments of methods according to the present disclosure;

FIG. 2B schematically illustrates the flow of various embodiments of a method performed by an NF according to the present disclosure;

FIG. 2C schematically illustrates the flow of various embodiments of a method performed by a CHF according to the present disclosure;

FIGS. 3A and 3B schematically illustrate various embodiments of NF entities according to the present disclosure;

FIGS. 4A and 4B schematically illustrate various embodiments of CHF entities according to the present disclosure, and

FIG. 5 schematically illustrates various embodiments of computer program products according to the present disclosure.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested.

### DETAILED DESCRIPTION

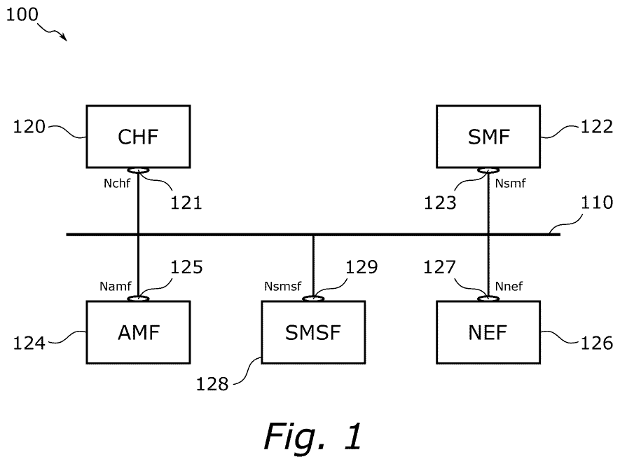

The embodiments of the present disclosure that will be presented later herein can be applied in a communication network such as e.g. a public land mobile network (PLMN). More in particular, it is envisaged that the embodiments presented herein apply at least to a reference architecture of a fifth-generation telecommunication system (5GS) or later, and parts of such a network especially relevant for the present disclosure will now be described in more detail with reference to FIG. 1.

FIG. 1 schematically illustrates part of a communication network 100, including several examples of Network Functions (NFs) 120, 122, 124, 126 connected together via a Service-Based Interface (SBI) topology built around a common communication bus 110. The NFs are respectively a (Converged) Charging Function (CHF) 120, a Session Management Function (SMF 122), an Access and Mobility Management Function (AMF) 124, a Network Exposure Function (NEF) 126, and a Short Message Service Function (SMSF) 128. The network 100 may of course also include one or more other/additional NFs, but for the purpose of avoiding obfuscation of the core idea behind the present disclosure, these are not illustrated in FIG. 1. Each one of the NFs 120, 122, 124, 126 and 128 has its own SBI 121, 123, 125, 127, 129 respectively, indicated in text on the format “N{x}”, where “{x}” is the abbreviation for the corresponding NF (such as Nchf for the CHF 120, Nsmf for the SMF 122, and so on). There may of course be other interfaces available, such as e.g. one or more point-to-point interfaces, but these have on purpose been omitted from FIG. 1. One or more of the NFs 120, 122, 124, 126, 128 may also have further connections also not shown in FIG. 1. For example, the illustrated NFs all form part of a Control Plane, and e.g. the SMF 122 and the AMF 124 may each have connections (via e.g. one or more point-to-point interfaces, not shown) to one or more functions of a User Plane. For more details, see e.g. 3GPP TS 23.501.

It is envisaged that the CHF 120 forms part of a so-called Converged Charging System (CCS) which may in turn interact with a billing system of e.g. a network operator running the network 100. The CHF 120 is responsible for both online and offline charging in a convergent manner, and operates to collect data on e.g. network resource usage from various NFs such as e.g. the SMF 122. To do so, the CHF 120 may provide a service Nchf_ConvergedCharging, including operations such as Create, Update and Release (as specified in 3GPP TS 32.291). The CHF 120 may also provide other services, such as e.g. Nchf_SpendingLimitControl (as specified in 3GPP TS 23.502). Using a resource and data model, all operations of e.g. the Nchf_ConvergedCharging are based on a HTTP method such as e.g. POST and DELETE. More details on how the CHF 120, according to already proposed architectures, interacts with e.g. the SMF 122 is found in 3GPP TS 32.290.

As described earlier herein, an NF such as the SMF 122 may indicate to the CHF 120 that it wants to initiate a charging session. To do so, the SMF 122 may send a charging data request [initial] to the CHF 120, which may respond back with a charging data response [initial]. To know which events that are to be monitored, the SMF 122 uses one or more charging triggers. As soon as such a charging trigger is activated, the SMF 122 sends another charging data request [update] to the CHF 120, informing the CHF 120 of which charging trigger that was activated, and e.g. together with for example a current data usage count or similar, such that the CHF 120 may properly handle the bookkeeping needed to keep track of e.g. the network data usage, service usage, etc., for which the user is to be billed. The CHF 120 may assist in configuring the charging triggers of the various NFs (such as the SMF 122) by providing a list of what charging triggers it wants the SMF 122 to use. As specified in 3GPP TS 32.291, such a list may be provided by the CHF 120 to the SMF 122 either in the response to the charging data request [initial], or in the response to the later charging data request [update]. Each such list may for example include, or at least be accompanied by, details about whether the charging triggers are to be applied on a rating group level or on a main (PDU) session level.

In such current architectures, it is thus possible to set charging trigger conditions in an NF, e.g. in the SMF 122, on a per-charging session basis, from the CHF 120. To do so, the CHF 120 may respond to an incoming charging data request from the SMF 122, and include the one or more charging trigger conditions which are to be set as part of a corresponding charging data response sent to the SMF 122 from the CHF 120. Such conditions may be specified to be immediate/deferred, enabled/disabled, and some may have values associated therewith, such as e.g. limits and thresholds.

As indicated earlier herein in e.g. the sections “Background” and “Summary”, one disadvantage with such a solution is that all trigger conditions that need to be enabled have to be included as part of such a charging data response. This because in current 3GPP-architectures, a trigger condition not being included as part of the charging data response is to be treated as an indication that such a trigger condition is to be disabled. In order to update a particular charging trigger condition, information pertinent to also all other charging triggers and conditions that are still to remain enabled must thus also be provided in the charging data response send to e.g. the SMF 122 from the CHF 120. As information is thus needed to be sent also for charging triggers and conditions which are not to be changed, some of the information sent across the network 100 may thus be considered as redundant, and to cause unnecessary consumption of network bandwidth.

Another disadvantage with such a solution is that all such configuration of charging triggers and conditions mediated via one or more charging data responses are necessarily applicable only on a per-charging session level/basis. Thus, if the CHF 120 would like to update one or more charging trigger conditions in the SMF 122 for e.g. a particular charging session, the CHF 120 would have to wait until the next charging data request for that charging session arrives from the SMF 122, such that the desired updates to the one or more charging trigger conditions can be provided to the SMF 122 as part of the corresponding, subsequent charging data response. As a consequence, as the CHF 120 may have to wait e.g. several seconds or more before a next charging data request arrives for a particular charging session, there can be a delay until a desired change of one or more charging trigger conditions is actually implemented in the SMF 122.

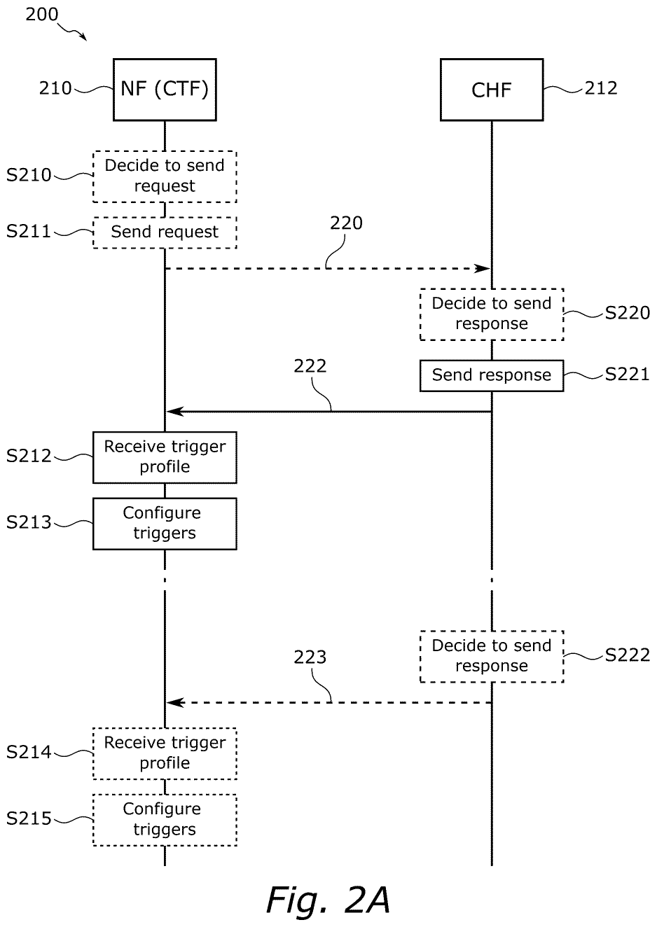

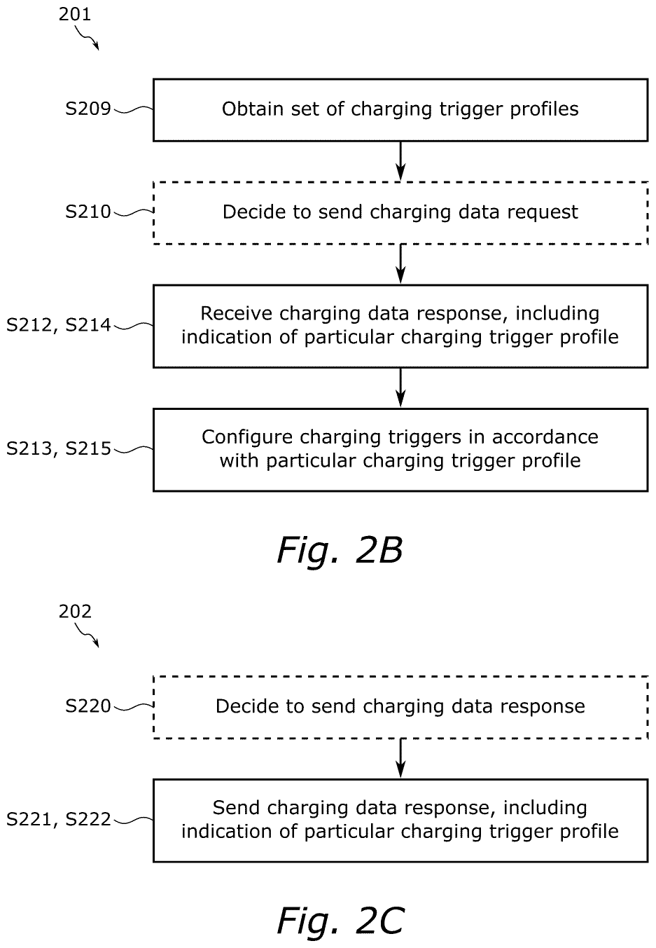

How the envisaged solution of the present disclosure improves upon such downsides with current architectures will now be described in more detail with reference also to FIGS. 2A-2C, 3A-3B, 4A-4B and 5 of the accompanying drawings, and illustrated by exemplifying embodiments of the various methods, entities, computer programs and computer program products envisaged herein. The drawings show only certain embodiments of the present disclosure. The invention of the present disclosure is defined and limited by the accompanying patent claims and may be embodied in many different forms, and should thus not be construed as limited only to the embodiments set forth herein; rather, these embodiments are provided for thoroughness and completeness, and fully convey the scope of the invention of the present disclosure to the skilled person.

To overcome such disadvantages of current architectures, the envisaged solution builds upon the realization that many users (e.g., subscribers) will require the same charging trigger settings, and that there are often only a limited number of all possible combinations of charging triggers and conditions that are actually applicable for the various users. Based on this realization, the present disclosure envisages to introduce so-called “charging trigger profiles”, which may either be managed from e.g. an operation support system, or be mediated as part of charging data responses sent by the CHF 120 to the NFs (such as to e.g. the SMF 122).

As envisaged herein, a charging trigger profile defines one or more configurations of charging triggers. Each such configuration corresponds to e.g. a list of charging triggers that are to be used by and enabled at the receiving NF, and may if needed also include e.g. values of one or more limits and/or thresholds that are to be used to properly define the conditions that need to be fulfilled for the charging trigger to be triggered and a corresponding charging event to be reported back to the CHF 120.

As envisaged herein, this may be accomplished by for example introducing one or more changes to 3Gpp TS 32.291. In particular, this may be accomplished by for example introducing a new attribute in the type “ChargingDataResponse”. This new attribute, which may be named for example “chargingTriggerProfileList”, may be defined as illustrated in Table 1.

TABLE 1
Envisaged addition to type ChargingDataResponse

| | | | | |
|---|---|---|---|---|
| Attribute name | Data type | P | Cardinality | Description |

. . .

| | | | | |
|---|---|---|---|---|
| chargingTriggerProfileList | map(TriggerProfileInfo) | O_{C} | o . . . N | When the data type is present in |
| | | | | response message, it may include |
| | | | | the charging trigger profile |
| | | | | information provisioned by the |
| | | | | CHF (and e.g. to be used for any |
| | | | | future request using the charging |
| | | | | trigger profile). |
| | | | | The attribute “triggerProfileId” |
| | | | | within the type TriggerProfileInfo |
| | | | | may be used as the key to the map. |

. . .

In case there is only a single charging trigger profile relevant for a particular NF, the attribute named “chargingTriggerProfileList” may e.g. be modified such that its data type instead corresponds to TriggerProfileInfo instead of map(TriggerProfileInfo).

In accordance with the above-mentioned addition to the type ChargingDataResponse, the present disclosure also envisages to introduce a new data type “TriggerProfileInfo”. This new data type may for example be defined as illustrated in Table 2.

TABLE 2
Envisaged new data type TriggerProfileInfo

| Attribute name | Data type | P | Cardinality | Description |
|---|---|---|---|---|
| triggerProfileId | String | O_{C} | o . . . 1 | Identifier for the charging trigger settings/ |
| | | | | charging trigger profile. |
| triggerLists | map(TriggerList) | O_{C} | o . . . N | The triggers settings that are applicable for |
| | | | | the charging profile, with one list for each |
| | | | | rating group or session level trigger. |
| | | | | The ratingGroup for which the triggers are |
| | | | | applicable may e.g. be used as key to the |
| | | | | map. If the triggers are for a PDU session, |
| | | | | the key may e.g. be set to “PDUSession” or |
| | | | | similar. |
| profileUpdateMode | ProfileUpdateMode | O_{C} | o . . . 1 | This field may indicate if the charging trigger |
| | | | | profile included is an update of the profile |
| | | | | as such or a change of charging trigger profile |
| | | | | for e.g. the charging session. |

It should be noted that in the exemplary TriggerProfileInfo data type, there may be multiple (different) lists of charging triggers, such that there may be one list of charging triggers for one rating group, another list of charging triggers for another rating group, and/or e.g. one list of charging triggers for the PDU session as a whole. In other embodiments, it may e.g. be envisaged to only provide one list of triggers which apply for all rating groups (e.g. on a PDU session-level only). In such a case, the definition of the data type TriggerProfileInfo may e.g. be changed such that the attribute named triggerLists is of the data type TriggerList instead of map(TriggerList), or similar.

In accordance with the above-mentioned new data type TriggerProfileInfo, it is also envisaged to introduce another new data type named for example “TriggerList”, as illustrated in Table 3. This new data type TriggerList can e.g. hold the charging triggers and all the limits, granted units and thresholds, and similar. The granted units may e.g. have one or more thresholds connected to them. The limits may e.g. be part of the charging trigger profile, which could also be the case for the granted units. However, as granted units are mainly used for online charging, this would more often apply in the case where the CHF is e.g. not reachable.

TABLE 3
Envisaged new data type TriggerList

| Attribute name | Data type | P | Cardinality | Description |
|---|---|---|---|---|
| ratingGroup | RatingGroup | O_{C} | o . . . 1 | The identifier of a rating group. If not |
| | | | | included, session level triggers may be |
| | | | | assumed. |
| triggers | array(Trigger) | O_{C} | o . . . N | This field may hold trigger(s) for e.g. |
| | | | | usage-reporting related to the charging |
| | | | | trigger profile. If not included, it is |
| | | | | envisaged that e.g. a default charging |
| | | | | trigger profile may be used. |
| limitList | array(QuotaInfo) | O_{C} | o . . . N | The limits for the triggers, only |
| | | | | applicable for “PDUSession”. If not |
| | | | | included, the limits for the default |
| | | | | charging trigger profile may be used. |
| grantedUnitList | array(QuotaInfo) | O_{C} | o . . . N | This field may hold e.g. the granted |
| | | | | quota, applicable for rating groups. |
| grantedUnitThresholdList | array(QuotaInfo) | O_{C} | o . . . N | The thresholds and limits for the |
| | | | | charging triggers. |
| validityTime | DurationSec | O_{C} | o . . . 1 | This field may e.g. define the time in |
| | | | | order to limit the validity of the |
| | | | | grantedUnit(s). If not included, the |
| | | | | value for the default charging trigger |
| | | | | profile may be used. |
| quotaHoldingTime | DurationSec | O_{C} | o . . . 1 | This field may e.g. hold the quota |
| | | | | holding time, i.e. the time duration |
| | | | | without any quota consumption, in e.g. |
| | | | | seconds for the grantedUnit(s). If |
| | | | | value is zero, they may be no limit for |
| | | | | the quota holding time. If not included, |
| | | | | the value for the default charging |
| | | | | trigger profile may be used. |
| finalUnitIndication | FinalUnitIndication | O_{C} | o . . . 1 | This field may indicate whether the |
| | | | | grantUnitList contains the final quota |
| | | | | for the service. |
| tariffTimeChange | DateTime | O_{C} | o . . . 1 | This field may contain e.g. UTC time |
| | | | | indicating the switch time when the |
| | | | | tariff will be changed, i.e. the used |
| | | | | units may be reported separately |
| | | | | before and after. |

In accordance with the above-described new data type TriggerProfileInfo, it is also envisaged to introduce a new data type named e.g. “ProfileUpdateMode”. This new data type may e.g. be an enumeration as illustrated in Table 4.

TABLE 4
Envisaged new data type ProfileUpdateMode

| Enumeration | |
|---|---|
| value | Description |
| CREATE | This value may be used to indicate that this is |
| | a create/creation of the charging trigger profile. |
| UPDATE | This value may be used to indicate that this is an |
| | update of the trigger settings for the charging |
| | trigger profile. |
| DELETE | This value may be used to indicate that this is a |
| | delete/deletion of the charging trigger profile. |

Using the new data type ProfileUpdateMode, it may be communicated from the CHF to the NF whether a particular charging trigger profile is to be e.g. created, updated, or deleted. It is envisaged that a charging trigger profile may be activated and used by the NF directly in response to receiving e.g. a ProfileUpdateMode of “CREATE” or “UPDATE”, and that e.g. a charging trigger profile may be deactivated and no longer used by the NF directly in response to receiving e.g. a ProfileUpdateMode of “DELETE”.

The various tables provided herein are only examples of one or more possible ways in which to embody the envisaged method. There may of course also be other alternatives for how to define and use the envisaged concept of charging trigger profiles which does not follow the organization and definitions of the various new data types discussed above. It may for example be envisaged not to have several layers of nested data types, but to instead include the same information in fewer data types. For example, it may be envisaged that all info needed to define one or more charging trigger profiles is included directly in the ChargingDataResponse, without referring to one or more additional new data types.

As a minimal envisaged requirement, the ChargingDataResponse should be modified in some way to at least provide an indication of a particular charging trigger profile. Such an indication may e.g. be a reference to an already (in the NF) available charging trigger profile. In situations where the particular charging trigger profile is not known by/available in the NF from before, it is envisaged that the ChargingDataResponse is modified to at least include sufficient information to define the particular charging trigger profile, i.e. to define the configuration of one or more charging triggers (and possibly also the corresponding limits, thresholds, and similar, if needed) that the CHF wants for the NF to use in order to generate and report charging events back to the CHF.

For example, it is envisaged that the ChargingDataResponse is modified such that it at least includes a charging trigger profile ID, which can be used as an indication for what particular charging trigger profile the CHF wants the NF to use. As described earlier herein, as only the charging trigger profile ID is needed to be communicated in case the corresponding charging trigger profile is already known to the NF, the amount of data communicated over the network may be reduced, as information about e.g. all active/enabled charging triggers themselves no longer need to be communicated from the CHF to the NF. As used herein, the expression “set of one or more charging trigger profiles” corresponds to what in e.g. Table 1 is referred to as a list/map of charging trigger profiles (e.g. map(TriggerProfileInfo)). Similarly, the expression “configuration of charging triggers” corresponds to what in e.g. Table 3 is referred to as an array/list of charging triggers (e.g. array (Trigger)), as well as all other limits, thresholds and similar applicable to such charging triggers.

As envisaged herein, in some embodiments, an attribute named e.g. “chargingTriggerProfileList” may also be included as part of a charging data request sent from the NF (CTF) to the CHF. One such example includes to modify the data type ChargingDataRequest in accordance with Table 5. In such embodiments, the NF (CTF) may inform the CHF which charging trigger profile that was used for a specific chargeable event. The charging data request could also e.g. include the trigger settings. The CHF could, in response, e.g. update this profile with the settings it would prefer, and communicate these desired changes to the NF (CTF) via the subsequent charging data response sent to the NF (CTF).

TABLE 5
Envisaged addition to type ChargingDataRequest

| | | | | |
|---|---|---|---|---|
| Attribute name | Data type | P | Cardinality | Description |

. . .

| | | | | |
|---|---|---|---|---|
| chargingTriggerProfileList | map(TriggerProfileInfo) | O_{C} | o . . . 1 | When the data type is present in |
| | | | | request message, it may be used to |
| | | | | report the charging trigger profile |
| | | | | used. Preferably, only the trigger |
| | | | | type within the trigger attribute |
| | | | | may be present. |
| | | | | The attribute “triggerProfileId” |
| | | | | within the type TriggerProfileInfo |
| | | | | may be used as the key to the map. |

. . .

An example flow of configuring of charging triggers as envisaged herein will now be described in more detail with reference also to FIGS. 2A-C.

FIG. 2A schematically illustrates a general flow 200 of how an NF (CTF) 210 and CHF 220 interact to configure charging triggers as envisaged herein, while FIGS. 2B and 2C show only those steps performed by each of the NF (CTF) and the CHF as part of such configuring.

In a step S210, the NF (CTF) 210 makes a decision that it wants to send a charging data request to the CHF 212. The exact reason for why to send such a charging data request may of course vary depending on exactly in what part of a charging session the NF (CTF) 210 is currently at. For example, the NF (CTF) 210 may have received a request for service delivery, e.g. when a particular user equipment (UE) wants to make a voice call or similar. The NF (CTF) 210 may then want to make the request to the CHF 212 in order for the CHF 212 to grant the service to start, or similar. In other examples, the delivery of the service may already be ongoing, and the NF (CTF) 210 may decide to send the request in order to report charging data related to a service delivered that is not under quota management, based on that a particular charging trigger for service usage reporting is met. As another alternative, the NF (CTF) 210 may want to send the request as part of quota management or similar, in order to request from the CHF 212 that e.g. more units are granted, for the service to continue, and e.g. to report a number of units used so far, or similar, in response to a charging trigger associated with quota management being met. In yet another example, the NF (CTF) 210 may want to send the request to the CHF 212 as part of a release of an ongoing service. The request may then e.g. include a final number of consumed units, or similar. As envisaged herein, the exact charging scenario leading up to the NF (CTF) 210 wanting to send a charging data request to the CHF 212 may for example be any of those described in 3GPP TS 32.290, e.g. for event based charging, session based charging, or similar. For further details and explanations of such possible charging scenarios, reference is thus made to 3GPP TS 32.290. Independent of exactly what the reason behind decision taken in step S210 is, the NF (CTF) 210 sends (in a step S211) the charging data request 220 to the CHF 212.

As envisaged herein, such a charging data request 220 may include an indication of what charging trigger profile the NF (CTF) 210 is going to use, for example if the charging data request is sent as part of the NF (CTF) wanting to start delivery of a service.

After having received the charging data request 220 from the NF (CTF) 210, the CHF 212 makes (in a step S220) a decision to send a charging data response back to the NF (CTF) 210. The decision in step S220 may be taken in response to e.g. receiving a request for authorizing a particular service to start, in response to e.g. receiving a request for reporting of charging data (usage reporting) and/or quota management, or e.g. in response to receiving a request for termination of an ongoing service, as described earlier herein. As mentioned earlier when discussing the possible reasons for the NF (CTF) 210 wanting to send a charging data request to the CHF 212, the possible reasons for why the CHF 212 wants to send a charging data response back to the NF (CTF) 210 are e.g. those corresponding to the charging scenarios described in 3GPP TS 32.290.

No matter what the reason behind the decision taken in step S220, the CHF 212 responds by (in a step S221) sending the charging data response 222 back to the NF (CTF) 210. Included in the charging data response 222 is at least one of i) an indication of a particular charging trigger profile (as described herein) that the CHF 212 wants the NF (CTF) 210 to use in order to report further charging events back to the CHF 212; ii) information sufficient to define a new charging trigger profile that the CHF wants the NF (CTF) 210 to use, and iii) information defining one or more updates to a particular charging trigger profile that the NF (CTF) 210 is already using. Optionally, it is envisaged that there may also be a further alternative iv) in which the CHF 212 provides information about a new, or updates to an existing, charging trigger profile that the NF (CTF) 210 is currently not using (or aware of), but such that the NF (CTF) 210 may use this new/updated charging trigger profile at a later time, e.g. if the CHF 212 later sends an indication of this charging trigger profile.

In a step S212, the NF (CTF) 210 receives the charging data response 222 and thereby also at least e.g. the indication of the particular charging trigger profile from the CHF 212.

In a step S213, the NF (CTF) 210 then configures itself to report charging events to the CHF 212 in accordance with at least one of the one or more configurations of charging triggers defined by the particular charging trigger profile.

As also illustrated in FIG. 2, there may optionally be one or more similar steps performed after e.g. step S212 or S213, wherein another charging data response is sent from the CHF 212 to the NF (CTF) 210. For example, in a step S222, the CHF 212 may (for some reason) send another charging data response 223 to the NF (CTF) 210, and the NF (CTF) 210 may receive this additional charging data response 223 in a step S214. In some embodiments, this charging data response may include an indication of a particular charging trigger profile that was obtained by the NF (CTF) 210 as part of an earlier-received charging data response. For example, the particular charging trigger profile may have been obtained by the NF (CTF) 210 as part of the charging data response 222 sent to the NF (CTF) 210 by the CHF 212 in the step S221. In such a situation, the later charging data response 223 sent by the CHF 212 in the step S222 may define one or more updates of the one or more configurations of charging triggers defined by the particular charging trigger profile, such that the NF (CTF) 210 may update (in a step S215) the particular charging trigger profile in accordance therewith. Phrased differently, it is thus envisaged that a particular charging trigger profile need not to remain constant, but may be updated at least once by the CHF 212 providing such updates to the NF (CTF) 210 as part of one or more later charging data responses (e.g. 223). In particular, the possibility to provide only updates of particular charging triggers, and without having to re-send all information pertinent to all other charging triggers each time, allows to reduce the amount of data sent across the network. The reason for sending the additional charging data response 223 may e.g. be in response to the CHF 212 receiving yet another charging data request (not shown) from the NF (CTF) 210. As will be described earlier herein, such another charging data request need not necessarily be for a same charging session as e.g. the charging data request 220.

In another example, it may be envisaged that the NF (CTF) 210 receives (in the step S212) the charging data response 222 as part of a first charging session, and that the NF (CTF) 210 receives (in the step S214) the additional charging data response 223 (sent by the CHF 212 to the NF (CTF) 210 in the step S222) as part of another, different charging session. In another example, receiving the additional charging data response 223 may be performed as part of the same charging session as before, but the NF (CTF) 210 may then at least wait with updating and/or switching to the charging trigger profile (e.g., step S213) as defined by the charging data response received in step S214 until, or for, another, different charging session.

No matter the exact order of events, the envisaged method of the present disclosure thus also allows to receive updates for a particular charging trigger profile as part of one charging session, and to implement (the changes required to conform to) this particular charging trigger profile as part of another charging session. This has the advantage that the CHF 212 does not need to wait for an incoming charging data request for the same charging session that it wants the NF (CTF) 210 to update the charging trigger profile for, but may respond with such changes to the NF (CTF) 210 as soon as a charging data request arrives for any charging session. As a result, the delay before a change of one or more charging triggers in any NF is completed may thus be reduced, as a charging data request for any charging session is likely to arrive within e.g. milliseconds or parts of a second, while it may take (considerably) longer before a charging data request for the same charging session to arrive.

FIG. 2B schematically illustrates the steps performed by the NF (CTF) 210 as part of configuring charging triggers therein. In a step S209, the NF 210 obtains the set of one or more charging trigger profiles as defined earlier herein, either based on operation support system management or as part of some charging data response received from the CHF 212. In the step S212 (or step S214), the NF 210 receives, as part of a charging data response from the CHF 212, the indication of the particular charging trigger profile in the set of one or more charging trigger profiles. As discussed earlier herein, the step S209 may also instead be performed as part of e.g. step S212, such that the full particular charging trigger profile and not only the indication thereof is received in a same charging data response from the CHF 212. The NF (CTF) 210 then, in the step S213 (or step S215), configures itself to report charging events to the CHF 212 in accordance with at least one of the one or more configurations of charging triggers defined by the particular charging trigger profile indicated in the charging data response received from the CHF 212 in the step S212 (or e.g. as part of the charging data response received from the CHF 212 in the step S214, or similar).

As described earlier herein, in the method 201, the NF (CTF) 210 may either receive the definition of the particular charging trigger profile and the indication about the particular charging trigger profile as part of a same charging data response, or in different charging data responses. Likewise, the NF (CTF) 210 may either apply the particular charging trigger profile for a same charging session as that for which either the definition or indication of the particular charging trigger profile was received, or e.g. receive the particular charging trigger profile (or indication thereof) as part of one charging session, and apply the (updated) particular charging trigger profile as part of another charging session. FIG. 2B illustrates the minimal number of steps required to perform the method 201 of configuring charging triggers in the NF (CTF) 210 as envisaged herein.

FIG. 2C schematically illustrates the steps of a method 202 for assisting in configuring in charging triggers in an NF (CTF) (such as 210), as performed by a CHF (such as 212) as envisaged herein. In the step S221 (or e.g. in the step S222), the CHF 212 sends the charging data response to the NF 210, wherein the charging data response includes at least an indication of a charging trigger profile defining one or more configurations of charging triggers, in accordance with which the NF (CTF) 210 should be configured (i.e., configure itself) to report charging events to the CHF 212. Before step S221 (or step S222), a decision may be taken by the CHF 212 to send the charging data response, as discussed earlier herein.

As described earlier herein, also the (definition of the) charging trigger profile, and not only the indication thereof, may be provided as part of the charging data response including the indication, or e.g. as part of a charging data response sent earlier to the NF (CTF) 210. If only the indication of a charging trigger profile is sent, it is assumed that the indicated charging trigger profile has already been configured somehow in the receiving NF (CTF) 210. If only a single charging trigger profile is provided as part of a charging data response sent from the CHF 212, it may e.g. be assumed that the charging trigger profile itself then serves as the indication.

As also described herein, in some embodiments of the method 202, the charging trigger profile itself may be provided as part of a first charging data response sent from the CHF 212 to the NF (CTF) 210, and the indication of the charging trigger profile may be provided as part of a second, later charging data response sent to the NF (CTF) 210, in which case the second charging data response may define one or more updates of the one or more configurations of charging triggers.

In general, the envisaged solution of the present disclosure is applicable both when charging takes place at the same time as a service is delivered/consumed (so-called Immediate Event Charging, IEC), as well as when charging takes place after the service has been delivered/consumed (so-called Post Event Charging, PEC).

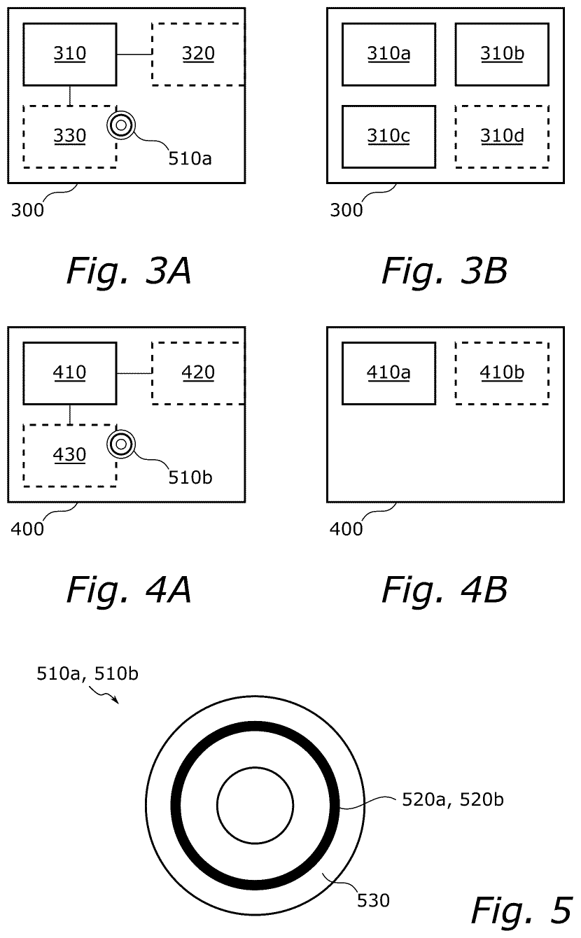

The present disclosure also envisages to provide NF and CHF entities configured to perform the respective parts of the improved methods described earlier herein. Such entities, as well as corresponding computer programs and computer program products will now be described in more detail with reference also to FIGS. 3A, 3B, 4A, 4B and 5.

FIG. 3A schematically illustrates, in terms of a number of functional units, the components of an embodiment of a Network Function (NF) entity 300 according to the present disclosure. The NF entity 300 is configured for configuring it charging triggers in accordance with the various methods described herein, and includes processing circuitry 310. The processing circuitry 310 is provided using any combination of one or more of a suitable central processing unit (CPU), multiprocessor, microcontroller, digital signal processor (DSP), etc., capable of executing software instructions stored in a computer program product 510a (see FIG. 5 and the description thereof), e.g. in form of a storage medium 330. The processing circuit 310 may further be provided as at least one application specific integrated circuit (ASIC), or field-programmable gate array (FPGA).

Particularly, the processing circuitry 310 is configured to cause the NF entity 300 to perform a set of operations, or steps, as disclosed above e.g. when describing the method 201 illustrated in FIG. 2B. For example, the storage medium 330 may store a set of operations, and the processing circuitry 310 may be configured to retrieve the set of operations from the storage medium 330 to cause the NF entity 300 to perform the set of operations. The set of operations may be provided as a set of executable instructions. Thus, the processing circuitry 310 is thereby arranged to execute methods associated with a NF as disclosed herein e.g. with reference to FIGS. 2A and 2B.

The storage medium 330 may also include persistent storage, which, for example, can be any single or combination of magnetic memory, optical memory, solid state memory or even remotely mounted memory.

The NF entity 300 may further include a communications interface 320 for communications with other entities, functions, nodes, and devices of the communication network. For example, the communications interface 320 may allow the NF entity 300 to communicate with e.g. a CHF entity, and/or with other NFs. As such, the communication interface 320 may include one or more transmitters and receivers, including analogue and/or digital components.

The processing circuitry 310 controls the general operation of the NF entity 300 e.g. by sending data and control signals to the communications interface 320 and the storage medium 330, by receiving data and reports from the communications interface 320, and by retrieving data and instructions from the storage medium 330. Other components, as well as their related functionality, of the NF entity 300 are omitted in order not to obscure the concepts presented herein.

FIG. 3B schematically illustrates, in terms of a number of functional modules 310a, 310b and 310c, the components of a NF entity 300 according to one embodiment of the present disclosure. The NF entity 300 includes at least an obtain module 310a configured to perform step S209 of the method 201 described with reference to FIG. 2B. The NF entity 300 also includes a receive module 310b configured to perform step S212 (and/or step S214), and a configurate module 310c configured to perform step S213 (and/or step S215). The NF entity 300 may also include one or more optional functional modules (illustrated by the dashed box 310d), such as for example a decide module configured to perform the step S210 of deciding to send a charging data request to the CHF entity, and/or a send module configured to perform the step S211 of sending the charging data request to the CHF entity. If one or more of these additional/optional steps S210 and S211 of the method 201 are not included, it is envisaged that the NF entity 300 does not require the corresponding functional blocks/modules 310d, or at least that these may still be included but put in an inactive state or similar.

In general terms, each functional module 310a-d may be implemented in hardware or in software. Preferably, one or more or all functional modules 310a-d may be implemented by the processing circuitry 310, possibly in cooperation with the communications interface 320 and/or the storage medium 330. The processing circuitry 310 may thus be arranged to from the storage medium 330 fetch instructions as provided by a functional module 310a-d, and to execute these instructions and thereby perform any steps of the method 201 performed by/in the NF entity 300 as disclosed herein. The processing circuitry 310, storage medium 330 and communications interface 320 may e.g. also be configured to implement a Charging Trigger Function (CTF) as described herein.

FIG. 4A schematically illustrates, in terms of a number of functional units, the components of an embodiment of a (Converged) Charging Function (CHF) entity 400 according to the present disclosure. The CHF entity 400 is configured for assisting in configuring charging triggers of an NF entity (such as the NF entity 300), and includes processing circuitry 410. The processing circuitry 410 is provided using any combination of one or more of a suitable central processing unit (CPU), multiprocessor, microcontroller, digital signal processor (DSP), etc., capable of executing software instructions stored in a computer program product 510b (see FIG. 5 and the description thereof), e.g. in form of a storage medium 430. The processing circuit 410 may further be provided as at least one application specific integrated circuit (ASIC), or field-programmable gate array (FPGA).

Particularly, the processing circuitry 610 is configured to cause the CHF entity 400 to perform a set of operations, or steps, as disclosed above e.g. when describing the method 202 illustrated in FIG. 2C. For example, the storage medium 430 may store a set of operations, and the processing circuitry 410 may be configured to retrieve the set of operations from the storage medium 430 to cause the CHF entity 400 to perform the set of operations. The set of operations may be provided as a set of executable instructions. Thus, the processing circuitry 410 is thereby arranged to (at least cause the CHF entity 400 to) execute methods as disclosed herein e.g. with reference to FIG. 2C.

The storage medium 430 may also include persistent storage, which, for example, can be any single or combination of magnetic memory, optical memory, solid state memory or even remotely mounted memory.

The CHF entity 400 may further include a communications interface 420 for communications with other entities, functions, nodes, and devices of the communication network. For example, the communications interface 420 may allow the CHF entity 400 to communicate with (another) NF entity, such as the NF entity 300. As such, the communication interface 420 may include one or more transmitters and receivers, including analogue and/or digital components.

The processing circuitry 410 controls the general operation of the CHF entity 400 e.g. by sending data and control signals to the communications interface 420 and the storage medium 430, by receiving data and reports from the communications interface 420, and by retrieving data and instructions from the storage medium 430. Other components, as well as their related functionality, of the CHF entity 400 are omitted in order not to obscure the concepts presented herein.

FIG. 4B schematically illustrates, in terms of at least one functional modules 410a, the components of a CHF entity 400 according to one embodiment of the present disclosure. The CHF entity 400 includes at least a send module 410a configured to perform step S221 (and/or the step S222) of the method 202 described with reference to FIG. 2C. The CHF entity 400 may also include one or more optional functional modules (as illustrated by the dashed box 410b), such as for example a decision module configured to perform the step S220 (of the method 202) of deciding to send a charging data response as envisaged herein, or similar. If e.g. the optional step S220 of the method 202 is not included, it is envisaged that the CHF entity 400 does not require the corresponding functional block/module 410b, or at least that this may still be included but put in an inactive state or similar.

In general terms, each functional module 410a and 410b may be implemented in hardware or in software. Preferably, one or all functional modules 410a and 410b may be implemented by the processing circuitry 410, possibly in cooperation with the communications interface 420 and/or the storage medium 430. The processing circuitry 410 may thus be arranged to from the storage medium 430 fetch instructions as provided by a functional module 410a and 410b, and to execute these instructions and thereby perform any steps of the method 202 performed by the CHF entity 400 as disclosed herein.

The CHF entity and/or NF entity may be provided as a standalone device or as part of at least one further device. For example, the CHF entity and/or NF entity may be provided in a node of the core network. Alternatively, functionality of the CHF entity and/or NF entity may be distributed between at least two devices, or nodes. These at least two nodes, or devices, may either be part of the same network part (such as e.g. the core network) or may be spread between at least two such network parts. For example, instructions that are required to be executed in real time may be performed in a device, or node, operatively closer to e.g. the cell than instructions that are not required to be performed in real time. In this respect, at least part of the CHF entity and/or NF entity may reside in the radio access network, such as in the radio access network node, for cases when embodiments as disclosed herein are performed in real time.

Thus, a first portion of the instructions performed by the CHF entity and/or NF entity may be executed in a first device, and a second portion of the instructions performed by the CHF entity and/or NF entity may be performed in a second device. The herein disclosed embodiments are however not limited to any particular number of devices on which the instructions performed by the CHF entity and/or NF entity may be executed. Hence, the methods according to the herein disclosed embodiments are suitable to be performed by a CHF entity and/or NF entity residing in a cloud computational environment. Therefore, although e.g. a single processing circuitry 310 and 410 is illustrated in each of FIGS. 3A and 4A, the processing circuitry 310 and 410 may be distributed among a plurality of devices, or nodes. The same applies also to the various functional modules 310a-d and 410a-b of FIGS. 3B and 4B and the computer programs 520a and 520b of FIG. 5.

Various computer program products according to the present disclosure will now be described in more detail with reference to FIG. 5.

FIG. 5 schematically illustrates a computer program product 510a, 510b including computer readable means 530. On the computer readable means 530, a computer program 520a can be stored, which computer program 520a can cause the processing circuitry 310 and thereto operatively coupled entities and devices, such as the communication interface 320 and the storage medium 330, to execute method 201 according to embodiments described herein with reference to FIG. 2B. The computer program 520a and/or computer program product 510a may thus provide means for performing any steps of the method 202 performed by the NF entity as disclosed herein. On the computer readable means 530, a computer program 520b can also be stored, either in addition to or instead of the computer program 520a, which computer program 520b can cause the processing circuitry 410 and thereto operatively coupled entities and devices, such as the communication interface 420 and the storage medium 430, to execute method 202 according to embodiments described herein with reference to FIG. 2C. The computer program 520b and/or computer program product 510b may thus provide means for performing any steps of the method 202 performed by the CHF entity as disclosed herein.

In the example of FIG. 5, the computer program product 510a, 510b is illustrated as an optical disc, such as a CD (compact disc) or a DVD (digital versatile disc) or a Blu-Ray disc. The computer program product 510a, 510b could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 520a, 520b is here schematically shown as a track on the depicted optical disk, the computer program 520a, 520b can be stored in any way which is suitable for the computer program product 510a, 510b.

In summary, the present disclosure presents an improved way of configuring charging triggers in an NF. By introducing charging trigger profiles which may be reused for e.g. multiple NFs and/or for multiple charging sessions, the envisaged improved way captures the realization that many charging sessions will require the same configuration of charging triggers, and that there are often only a limited number of different combinations of charging triggers that are used. By so doing, the need to resend data for all charging triggers as soon as e.g. a single charging trigger is to be updated in an NF is removed, and the amount of data traffic thus generated can be reduced. In addition, as the charging trigger profiles may be used for different charging sessions, the CHF no longer has to wait for a charging data request associated with a same charging session to arrive before a reconfiguration of a charging trigger may be completed. Instead, it is sufficient to wait for a next charging data request for any charging session to arrive, which is likely to arrive much quicker than if waiting for a request for a particular charging session. This reduces the delay until an update of a charging trigger can be completed in an NF. With the envisaged improved way of configuring charging triggers in an NF, the operator and the CHF is given more control on how to dynamically (re-) configure the charging triggers in an NF. This is important, as charging triggers play a critical role in rating conditions and what events to be applied for session-based charging or event-based charging, and the present disclosure therefore provides an improvement in this field.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

1. A method for configuring charging triggers in a Network Function, NF, the method being performed by the NF, the method comprising:
obtaining a set of one or more charging trigger profiles, wherein each charging trigger profile defines one or more configurations of charging triggers;
receiving, as part of a charging data response from a Charging Function, CHF, an indication of a particular charging trigger profile in the set of one or more charging trigger profiles; and
configuring the NF to report charging events to the CHF in accordance with at least one of the one or more configurations of charging triggers defined by the particular charging trigger profile.

2. The method according to claim 1, wherein at least the particular charging trigger profile is obtained as part of the charging data response received from the CHF.

3. The method according to claim 1, wherein at least the particular charging trigger profile has been configured in the NF before receiving the charging data response from the CHF.

4. The method according to claim 1, wherein the method comprises:
obtaining the particular charging trigger profile as part of a first charging data response from the CHF;
receiving the indication of the particular charging trigger profile as part of a second charging data response from the CHF, wherein the second charging data response is received later from the CHF than the first charging data response, and wherein the second charging data response defines one or more updates of the one or more configurations of charging triggers defined by the particular charging trigger profile; and
applying said one or more updates as part of said configuring the NF.

5. The method according to claim 1, wherein the method comprises:
receiving the charging data response from the CHF as part of a first charging session; and
configuring the NF for a second charging session different from the first charging session.

6. The method according to claim 1, wherein the one or more configurations of charging triggers for the particular charging trigger profile includes a configuration of charging triggers for each of a plurality of different rating groups, and wherein the method comprises configuring the NF in accordance with the configuration of charging triggers for a particular one of said different rating groups.

7. A method for assisting in configuring of charging triggers in a Network Function, NF, the method being performed by a Charging Function, CHF, the method comprising:
sending a charging data response to the NF, wherein the charging data response comprises an indication of a charging trigger profile defining one or more configurations of charging triggers, in accordance with which the NF should be configured to report charging events to the CHF.

8. The method according to claim 7, wherein the method comprises providing the charging trigger profile as part of the charging data response sent to the NF.

9. The method according to claim 7, wherein the charging trigger profile has been configured in the NF before sending the charging data response to the NF.

10. The method according to claim 7, wherein the method comprises:
providing the charging trigger profile as part of a first charging data response sent to the NF; and
providing the indication of the charging trigger profile as part of a second charging data response sent to the NF, wherein the second charging data response is sent later to the NF than the first charging data response, and wherein the second charging data response defines one or more updates of the one or more configurations of charging triggers.

11. A Network Function, NF, entity, the NF entity comprising processing circuitry, the processing circuitry being configured to cause the NF entity to:
obtain a set of one or more charging trigger profiles, wherein each charging trigger profile defines one or more configurations of charging triggers;
receive, as part of a charging data response from a Charging Function, CHF, entity, an indication of a particular charging trigger profile in the set of one or more charging trigger profiles; and
configure the NF entity to report charging events to the CHF entity in accordance with at least one of the one or more configurations of charging triggers defined by the particular charging trigger profile.

12. The NF entity of claim 11, wherein at least the particular charging trigger profile is obtained as part of the charging data response received from the CHF.

13. A Charging Function, CHF, entity, the CHF entity comprising processing circuitry, the processing circuitry being configured to cause the CHF entity to:
send a charging data response to a Network Function, NF, entity, wherein the charging data response includes an indication of a charging trigger profile defining one or more configurations of charging triggers, in accordance with which the NF entity should be configured to report charging events to the CHF entity.

14. The CHF entity according to claim 13, wherein the charging trigger profile has been configured in the NF before sending the charging data response to the NF.

15.-18. (canceled)

19. The NF entity of claim 11, wherein at least the particular charging trigger profile has been configured in the NF before receiving the charging data response from the CHF.

20. The NF entity of claim 11, wherein the processing circuitry being configured to cause the NF entity to perform operations comprising:
obtain the particular charging trigger profile as part of a first charging data response from the CHF;
receive the indication of the particular charging trigger profile as part of a second charging data response from the CHF, wherein the second charging data response is received later from the CHF than the first charging data response, and wherein the second charging data response defines one or more updates of the one or more configurations of charging triggers defined by the particular charging trigger profile; and
apply said one or more updates as part of said configuring the NF.

21. The NF entity of claim 11, wherein the processing circuitry being configured to cause the NF entity to perform operations comprising:
receive the charging data response from the CHF as part of a first charging session; and
configure the NF for a second charging session different from the first charging session.

22. The NF entity of claim 11, wherein the one or more configurations of charging triggers for the particular charging trigger profile includes a configuration of charging triggers for each of a plurality of different rating groups, and wherein the method comprises configuring the NF in accordance with the configuration of charging triggers for a particular one of said different rating groups.

23. The CHF entity according to claim 13, wherein the method comprises providing the charging trigger profile as part of the charging data response sent to the NF.

24. The CHF entity according to claim 13, wherein the processing circuitry being configured to cause the CHF entity to perform operations comprising:
provide the charging trigger profile as part of a first charging data response sent to the NF; and
provide the indication of the charging trigger profile as part of a second charging data response sent to the NF, wherein the second charging data response is sent later to the NF than the first charging data response, and wherein the second charging data response defines one or more updates of the one or more configurations of charging triggers.
